(19) United States
(12) Patent Application Publication
(10) Pub. No.: US 2024/0179371 A1
(43) Pub. Date: May 30, 2024

(54) VIDEO MANAGEMENT DEVICE, VIDEO MANAGEMENT SYSTEM, AND VIDEO MANAGEMENT METHOD

(71) Applicant: SHARP KABUSHIKI KAISHA, Osaka (JP)

(72) Inventor: TAKASHI USUI, Osaka (JP)

(21) Appl. No.: 18/504,288

(22) Filed: Nov. 8, 2023

(30) Foreign Application Priority Data
Nov. 25, 2022 (JP) 2022-188274

(51) Int. Cl. H04N 21/4415; G06V 20/40; G06V 40/16; H04N 21/4223; H04N 21/462

(52) U.S. Cl. CPC H04N 21/4415; G06V 20/41; G06V 40/172; H04N 21/4223; H04N 21/462

(57) ABSTRACT

A video management device includes: a storage that stores content; a viewer information requester that requests a terminal issuing a viewing request to capture an image of a face of a viewing requester; a relationship determiner that determines a relationship between a video of viewing requester received from the terminal and a viewing-request target content that is a target of the viewing request in the content; and a viewing condition determiner that determines a viewing condition of the viewing-request target content in accordance with the relationship.

### INCORPORATION BY REFERENCE

The present application claims the benefit of priority under 35 U.S.C. 119 based on Japanese Patent Application No. 2022-188274 filed on Nov. 25, 2022, and the disclosure of which is incorporated herein by reference in its entirety.

### BACKGROUND

The disclosure relates to a video management device and the like that manage content including still images and moving images, and particularly to a video management device, a video management system, and a video management method that control access restriction to content in accordance with whether or not a viewing requester is included as a subject.

There is known a conventional technique for personal information protection in which, when a person other than a user (registered) is captured in an image taken with a camera, image processing is executed to reduce (blur) the sharpness of the range of the person through mosaic processing or the like.

There are also known techniques to extract from a captured image an image of each person included in the captured image and correlate preferences (corresponding to user IDs and browsing restrictions) acquired from a mobile phone terminal, and to convert the images of persons corresponding to the preferences into dummy images.

### SUMMARY

A video management device according to the disclosure includes: a storage that stores content; a viewer information requester that requests a terminal issuing a viewing request to capture an image of a face of a viewing requester; a relationship determiner that determines a relationship between a viewer video received from the terminal and a viewing-request target content that is a target of the viewing request in the content; and a viewing condition determiner that determines a viewing condition of the viewing-request target content in accordance with the relationship.

A video management system according to the disclosure includes a video management device, and a terminal. A video management device according to the disclosure includes: a video-management-device-side communicator that communicates with the terminal; a storage that stores content; a viewer information requester that requests a terminal issuing a viewing request to capture an image of a face of a viewing requester; a relationship determiner that determines a relationship between a viewer video and a viewing-request target content that is a target of the viewing request in the content, each time the viewer video is received; and a viewing condition determiner that determines a viewing condition of the viewing-request target content in accordance with the relationship. The terminal includes: an image capturer that continuously, intermittently, or irregularly captures image of a face of the viewing requester; a viewing-requester detector that detects replacement of the viewing requester based on the viewer video captured by the image capturer; and a terminal-side communicator that transmits the viewer video first captured by the image capturer to the video management device, and transmits the viewer video to the video management device when the viewing-requester detector detects replacement of the viewing requester. A terminal used in such a video management system is also included in the scope of the disclosure.

The video management method includes: a viewer information requesting step of requesting a terminal that has issued a viewing request to capture an image of the face of a viewing requester; a relationship determining step of determining a relationship between a viewer video received from the terminal and a viewing-request target content that is a target of the viewing request in the content; and a viewer condition determining step of determining a viewing condition of the viewing-request target content in accordance with the relationship.

### BRIEF DESCRIPTION OF THE DRAWINGS

FIG. 1 is a diagram illustrating a schematic operation of a video management system 10 according to the first embodiment of the disclosure.

FIG. 2 is a block diagram illustrating a schematic configuration of the video management system 10.

FIG. 3 is a flowchart illustrating a schematic operation of the video management server according to the first modification of the first embodiment of the disclosure.

FIG. 4 is a flowchart illustrating a schematic operation of the video management server according to the second embodiment of the disclosure.

FIG. 5 is a flowchart illustrating a schematic operation of the video management server according to the modification of the second embodiment of the disclosure.

FIG. 6 is an explanatory diagram illustrating relationship determination and viewing conditions by the video management system according to the third embodiment of the disclosure.

FIG. 7 is an explanatory diagram illustrating relationship determination and viewing conditions by the video management system according to the fourth embodiment of the disclosure.

FIG. 8 is an explanatory diagram illustrating relationship determination and viewing conditions by the video management system according to the fifth embodiment of the disclosure.

FIG. 9 is an explanatory diagram exemplifying a case where the viewing condition is unlimited by the video management system according to the sixth embodiment of the disclosure.

FIG. 10 is an explanatory diagram exemplifying a case where a viewing condition by the video management system in FIG. 9 is changed from unlimited.

FIG. 11 is a block diagram illustrating a schematic configuration of a video management system 10A according to the eighth embodiment of the disclosure.

FIG. 12 is a block diagram illustrating a schematic configuration of a smartphone 30B according to the tenth embodiment of the disclosure.

FIG. 13 is a block diagram illustrating a schematic configuration of a smartphone 30C according to the eleventh embodiment of the disclosure.

### DETAILED DESCRIPTION

Embodiments of the disclosure are described below with reference to the drawings. In the drawings, the same reference signs are given to the same or similar components and the description of such components will not be repeated. The configurations that are not specifically mentioned in each of the embodiments and modifications are the same as those described earlier.

### First Embodiment

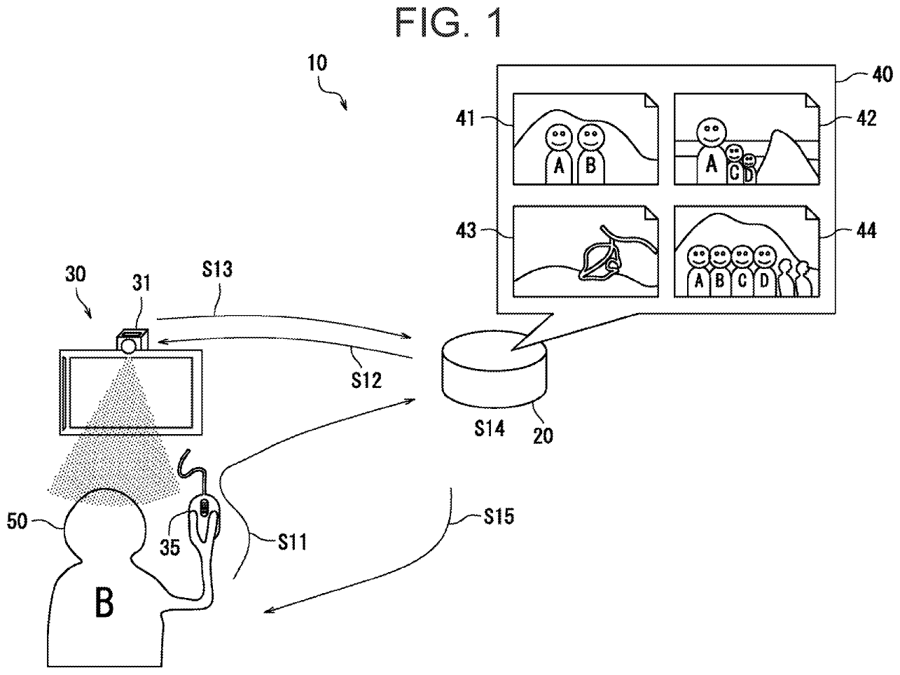

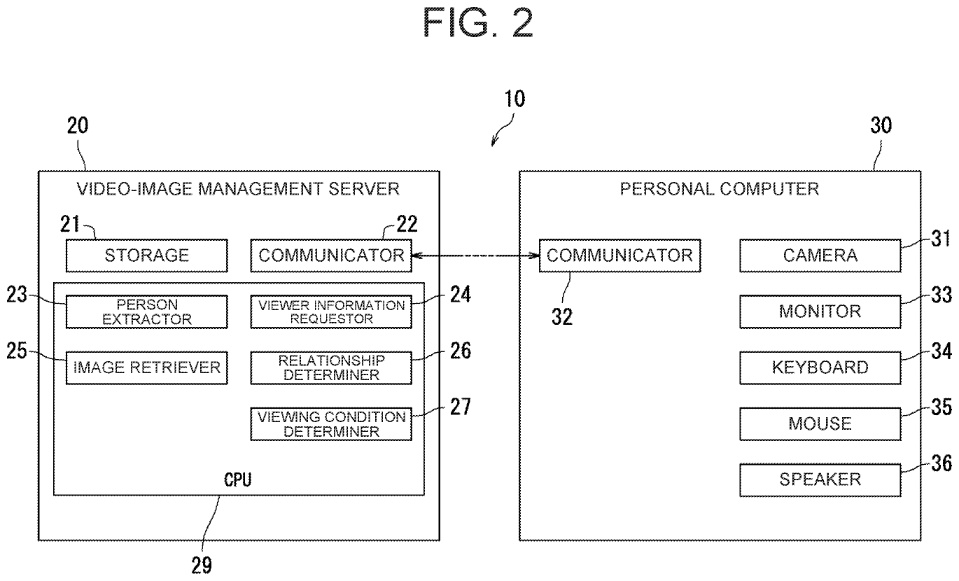

FIG. 1 is a diagram illustrating a schematic operation of a video management system 10 according to the first embodiment of the disclosure. FIG. 2 is a block diagram illustrating a schematic configuration of the video management system 10. The term “video” in the disclosure is a broad concept including not only moving images but also a still images. Examples of content of the disclosure includes not only “video” in this sense, but also documents and data in various formats including “video” (to which the “video” is attached).

### 1.1 Configuration of Video Management System 10

As illustrated in FIGS. 1 and 2, the video management system 10 includes a video management server 20 that manages content 40 and a desktop personal computer 30 that is used by a viewing requester 50 (person B, for example) to issue a viewing request for the content 40.

As illustrated in FIG. 2, the video management server 20 includes a central processing unit (CPU) 29 that controls each component, a storage 21 that stores necessary information and programs executed by the CPU 29, and a communicator 22. The CPU 29 may be, for example, one or a plurality of processors or one or a plurality of micro processing units (MPU), but is not limited thereto. The video management server 20 corresponds to a “video management device” of the disclosure. Since the hardware configuration of the video management server 20 is the same as that of a typical computer for a server, a detailed description thereof will be omitted.

The CPU 29 includes a person extractor 23, a viewer information requester 24, an image retriever 25, a relationship determiner 26, and a viewing condition determiner 27. For example, if programs of functions corresponding to the person extractor 23, the viewer information requester 24, the image retriever 25, the relationship determiner 26, and the viewing condition determiner 27 are stored in the storage 21, the CPU 29 executes the programs to implement the respective components. In addition, each of the components may be implemented by an electronic circuit, a digital signal processor (DSP), a field programmable gate array (FPGA), an application specific integrated circuit (ASIC), or the like, but is not limited thereto.

The storage 21 stores content 40 such as still images and moving images. The storage 21 includes a memory, specifically, a volatile memory and a nonvolatile memory. Examples of the volatile memory include, but are not limited to, a dynamic random access memory (DRAM) and a static random access memory (SRAM). Examples of the non-volatile memory include, but are not limited to, a read-only member (ROM), a flash memory, a solid state drive (SSD), and a hard disk.

The communicator 22 is connected to a communicator 32 of the personal computer 30 in a wired or wireless manner, and performs bidirectional communication. The communicator 22 corresponds to a “video-management-device-side communicator” of the disclosure.

The person extractor 23 extracts a person (subject) by performing image analysis on the content 40 stored in the storage 21.

The viewer information requester 24 requests the personal computer 30, which has issued the viewing request, to capture an image the face of the viewing requester 50.

The image retriever 25 retrieves a person corresponding to the face image of the viewing requester 50 received from the personal computer 30 from among the persons extracted by the person extractor 23.

The relationship determiner 26 determines the relationship between the face image of the viewing requester 50 and the viewing-request target content that is the target of the viewing request in the content 40. The “face image” corresponds to a “face video” of the disclosure.

The viewing condition determiner 27 determines the viewing condition of the viewing-request target content in accordance with the relationship determined by the relationship determiner 26.

The personal computer 30 includes a camera 31, a communicator 32, a monitor 33, a keyboard 34, a mouse 35, and a speaker 36. The personal computer 30 is an example of a “terminal” of the disclosure. Other examples of the “terminal” include laptop computers equipped with or having externally attached World Wide Web (Web) cameras, and smartphones and tablets equipped with in-cameras. Since the hardware configurations of these components are well known, detailed descriptions thereof will be omitted.

The camera 31 is disposed at a position suitable for capturing an image of the face of the viewing requester 50 using the personal computer 30, for example, at the upper end of the monitor 33. The camera 31 corresponds to an “image capturer” of the disclosure.

The communicator 32 is connected to the communicator 22 of the video management server 20 in a wired or wireless manner, and performs bidirectional communication. The communicator 32 corresponds to a “terminal-side communicator” of the disclosure.

Examples of the monitor 33 include, but are not limited to, a liquid crystal display.

The mouse 35 is a pointing device for inputting various operations for the viewing requester 50 to issue a viewing request for the content 40 to the personal computer 30. Not only the mouse 35 but also, for example, the keyboard 34 may be used for the viewing request.

As illustrated in FIG. 1, the content 40 includes at least the following four photographs 41 to 44. In many cases, the term “appear” is used for a still image such as a photograph, and the term “appear” is used for a moving image. In the disclosure, as described above, the term “video” is used as a concept in a broad sense including a still image, and thus “appear” in both a still image and a moving image will be used.

Photograph 41: person A and person B appear larger and in substantially the same size.

Photograph 42: person A appears large, person B appears small, and person D appears even smaller.

Photo 43: a landscape photograph in which no person appears.

Photograph 44: persons A to D appear small and in substantially the same size, and the other two persons appear smaller.

### 1.2 Operation of Video Management System 10

As illustrated in FIG. 1, the video management system 10 surely confirms whether or not the viewing requester 50 is the person with the confirmed identity mainly by the following five steps, and accurately controls the access restriction to the content 40 in accordance with the actual viewing requester 50.

### S11: Viewing Request

When the viewing requester 50 wants to view the content 40 managed by the video management server 20, the viewing requester 50 performs a predetermined operation using the mouse 35 of the personal computer 30 in order to issue a viewing request for the viewing-request target content. Accordingly, the viewing request issued from the personal computer 30 is transmitted to the video management server 20 via the communicator 32.

### S12: Viewer Information Request

When the communicator 22 of the video management server 20 receives a viewing request issued from the personal computer 30, the viewer information requester 24 requests the personal computer 30 to capture viewer information, specifically, the face of the viewing requester 50. S12 corresponds to a “viewer information requesting step” of the disclosure.

### S13: Viewer Information Provision

Upon receiving a viewer information request from the video management server 20, the personal computer 30 captures an image of the face of the viewing requester 50 with the camera 31, and provides this face image as a viewer video to the video management server 20 via the communicator 22.

### S14: Cross-Checking

The relationship determiner 26 of the video management server 20 determines the relationship between the viewer video received from the personal computer 30 and the viewing-request target content. Specifically, the relationship determiner 26 cross-checks whether or not each subject in the video included in the viewing-request target content is the person in the viewer video, that is, the viewing requester 50. S14 corresponds to a “relationship determining step” of the present disclosure.

For example, in the case of photographs 41 and 44, since one of the subjects is person B, it is determined that person B is the viewing requester 50. In the case of photographs 42 or photograph 43, it is determined that person B, i.e., the viewing requester 50 does not appear.

When a large number of persons appear in one photograph, the calculation load for the cross-checking and determination with the viewing requester 50 may become excessive. It can be said that there is a possibility that the accuracy of cross-checking with a person who is appears small is reduced, and that there is not much problem from the viewpoint of personal information protection if the person appears small.

Therefore, for example, a subject having a size smaller than half the size of the largest subject in one photograph may be excluded from the target of cross-checking and determination. In the case of photograph 42, persons C and D who have a size smaller than half of the largest person A are excluded from the target of cross-checking and determination. In the case of photograph 44, two persons appearing small other than the largest persons A to D are excluded from the target of cross-checking and determination.

However, the criterion for exclusion need not be uniformly less than half, and may be less than ⅓. Alternatively, up to a predetermined number of persons in descending order of size may be set as the targets of cross-checking and determination. For example, if the criterion for the number of persons is four, not only person A but also persons C and D are the targets of cross-checking and determination in photograph 42. The size of a person, the number of persons, or the like serving as a criterion for determining whether or not a person is a target of cross-checking and determination may be changed in accordance with the resolution of a photograph, the arithmetic processing performance of the video management server 20, or the like.

### S15: Video Data Provision

The viewing condition determiner 27 of the video management server 20 determines the viewing condition of the viewing-request target content in accordance with the relationship determined by the relationship determiner 26. S15 corresponds to a “viewer condition determining step” of the disclosure.

As an example of the viewing condition, viewing of photograph 42 in which the viewing requester 50 does not appear is not permitted. Image processing (hereinafter, referred to as “predetermined image processing”) is also performed on photographs 41 and 44 in which the viewing requester 50 appears so that a person other than the viewing requester 50 is not identified. Examples of such predetermined image processing include, but are not limited to, blurring, mosaic processing, resolution reduction, and replacement with an avatar or another person video. Photograph 43 does not show the viewing requester 50 and also does not show any other person, and thus there is no particular problem from the viewpoint of personal information protection. Therefore, viewing may be exceptionally permitted. Image processing corresponds to “video processing” of the disclosure.

As another example of the viewing condition, only preview is permitted for photograph 42 that does not show the viewing requester 50, or predetermined image processing is performed on each person. Photographs 41 and 44 showing the viewing requester 50 are allowed to be viewed in the original state without executing the predetermined image processing on persons other than the viewing requester 50. Photograph 43 is the same as in the above example.

According to such a configuration, it is possible to accurately control the access restriction to the content in accordance with the actual viewing requester 50 through reliable confirmation of the viewing requester 50, and to implement an advanced personal information protection function.

### First Modification of First Embodiment

In the above-described video management system 10, upon reception of a viewing request issued from the personal computer 30, the viewer information requester 24 of the video management server 20 always requests the personal computer 30 to capture viewer information, that is, the face of the viewing requester 50. However, if a face image is not included in the viewing-request target content, such a request may be omitted.

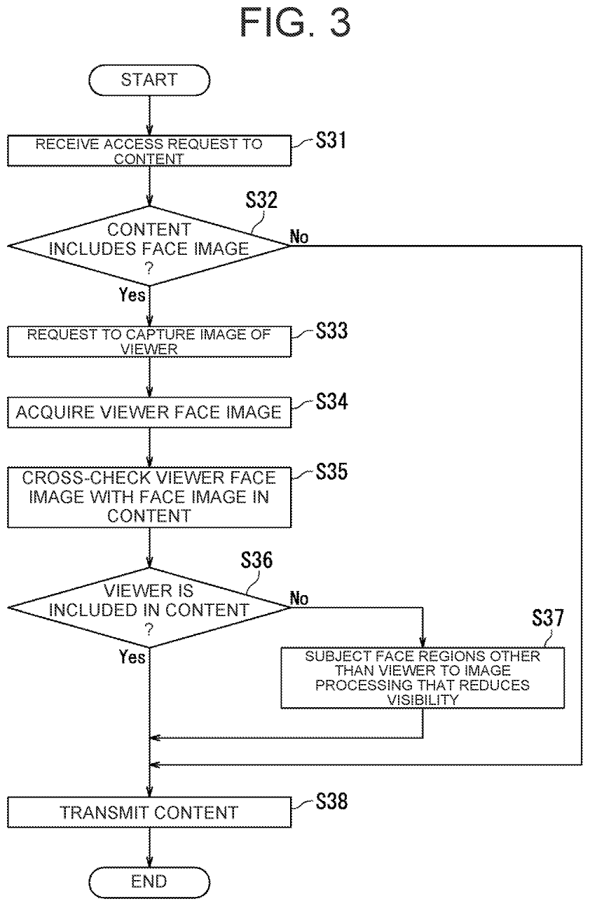

FIG. 3 is a flowchart illustrating a schematic operation of the video management server according to the first modification of the first embodiment of the disclosure. The difference from the first embodiment lies in the presence of step S32.

As illustrated in FIG. 3, in step S31, the communicator 22 of the video management server 20 receives a viewing request issued from the personal computer 30.

In step S32, it is determined whether or not a face image is included in the viewing-request target content for which a viewing request has been issued, and if it is included, the process proceeds to step S33, and if not, the process proceeds to step S38.

In step S33, the personal computer 30 is requested to capture an image of the face of the viewing requester 50 via the communicator 22.

In step S34, a face image is acquired from the personal computer 30 via the communicator 22.

In step S35, the acquired face image is cross-checked with the face image of each subject in the video included in the viewing-request target content.

In step S36, it is determined whether or not the viewing requester 50 is included in the viewing-request target content on the basis of the cross-check result in step S35, and if it is included, the process proceeds to step S38, and if not, the process proceeds to step S37.

In step S37, predetermined image processing for reducing visibility is executed on the face region of each subject other than the viewing requester 50.

Finally, in step S38, the viewing-request target content is transmitted to the personal computer 30 via the communicator 22.

According to such a configuration, for each content 40 managed by the video management server 20, only the person captured in an image can view the image clearly without requiring a troublesome pre-registration operation or the like, and viewing can be restricted for any other persons.

### Second Modification of First Embodiment

In the above-described video management system 10, the viewer information requester 24 of the video management server 20 always requests the personal computer 30, which has issued the viewing request, to capture an image of the face of the viewing requester 50, but it is assumed that this request and the acquisition of the face image of the viewing requester 50 are performed only once. Therefore, a time lag may occur until the content 40 is actually viewed due to the time required for various processes, the communication band, and the like. Since there is a possibility that the viewing requester 50 is replaced with another person during this time, for example, the following measures may be taken.

When the video management server 20 receives a viewing request issued from the personal computer 30, the viewer information requester 24 of the video management server 20 requests the personal computer 30 to continuously, intermittently, or irregularly capture images of the face of the viewing requester 50. This is to quickly detect a change in the viewing requester 50 after the first image-capturing. Since continuous image-capturing consumes a large amount of power, intermittent image-capturing may be performed. However, since there is a possibility of overlooking an intentional deception when the cycle is grasped in the image-capturing of the fixed time cycle, the image-capturing may be replaced with irregular image-capturing.

The relationship determiner 26 of the video management server 20 determines the relationship between each viewer video received from the personal computer 30 and the viewing-request target content. At this time, when it is detected that the viewing requester 50 has been replaced, the relationship between the viewer video and the viewing-request target content is determined again.

The viewing condition of the viewing-request target content is determined again in accordance with the relationship determined again by the viewing condition determiner 27 and the relationship determiner 26 of the video management server 20, and the viewing-request target content is provided after predetermined image processing or the like is executed if necessary. When the viewing requester 50 is replaced with another person, provision of the viewing-request target content may be stopped.

If the viewing-request target content once provided to the personal computer 30 remains displayed for a long time, the above-described measures will not be effective. Therefore, when the replacement of the viewing requester 50 is detected, it is preferred that the display on the personal computer 30 is once erased or the display on the personal computer 30 is always updated at a constant interval.

Such an update may be incorporated as a function in an application on the personal computer 30, or may be implemented by setting of meta refresh in the case of HTML content to be viewed with a browser.

### Second Embodiment

In the second embodiment, setting information of viewing permission level is included in the content 40 managed by the video management server 20, and the viewing condition is determined on the basis of the setting information. Here, the “viewing permission level” sets the degree of severity of viewing permission, for example, whether viewing is permitted or not in accordance with whether or not a person in question appears in each video, or whether viewing of the entire document is permitted as a related person if the face of the related person appears somewhere in the document including the video.

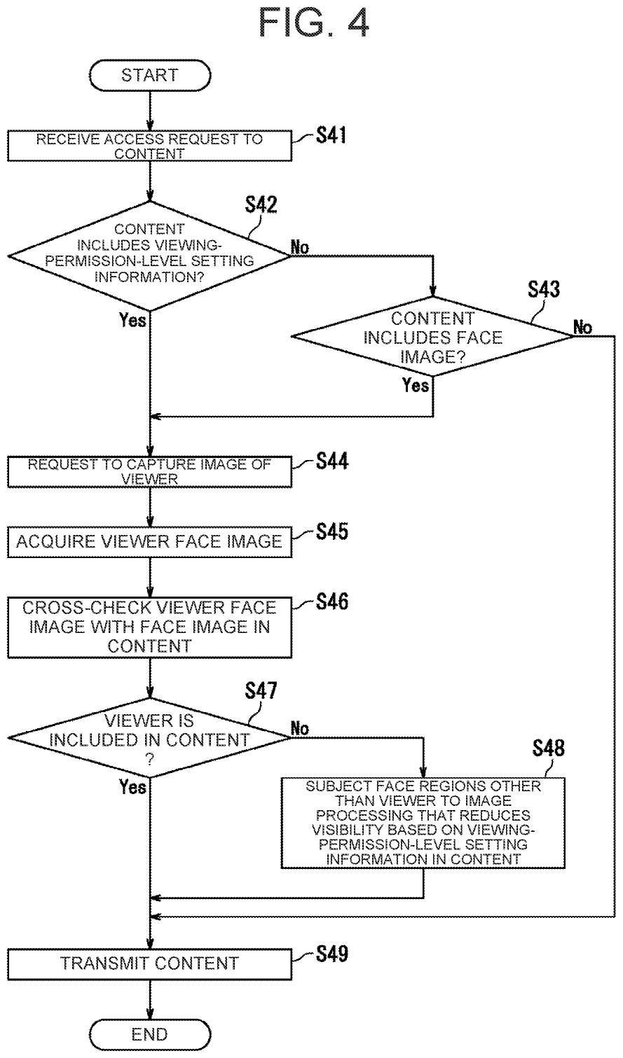

FIG. 4 is a flowchart illustrating a schematic operation of the video management server according to the second embodiment of the disclosure.

As illustrated in FIG. 4, in step S41, the communicator 22 of the video management server 20 receives a viewing request issued from the personal computer 30.

In step S42, it is determined whether or not the setting information of the viewing permission level is included in the content 40, and if included, the process proceeds to step S44, and if not, the process proceeds to step S43.

In step S43, it is determined whether or not a face image is included in the viewing-request target content for which a viewing request has been issued, and if it is included, the process proceeds to step S44, and if not, the process proceeds to step S49.

In step S44, the personal computer 30 is requested to capture an image of the face of the viewing requester 50 via the communicator 22.

In step S45, a face image is acquired from the personal computer 30 via the communicator 22.

In step S46, the acquired face image is cross-checked with the face image of each subject in the video included in the viewing-request target content.

In step S47, it is determined whether or not the viewing requester 50 is included in the viewing-request target content on the basis of the cross-check result in step S46, and if it is included, the process proceeds to step S49, and if not, the process proceeds to step S48.

In step S48, predetermined image processing is executed on the face region of each subject other than the viewing requester 50 on the basis of the viewing-permission-level setting information included in the viewing-request target content, as in step S37.

Finally, in step S49, the viewing-request target content is transmitted to the personal computer 30 via the communicator 22.

According to such a configuration, the setting information of the viewing permission level is included in each content 40 managed by the video management server 20, and the viewing condition is determined on the basis of the setting information. In this way, it is possible to set whether to restrict viewing by blurring the viewing of subjects other than the viewing requester in the same image, or to enable viewing of an image with no viewing restriction for all of the persons in the image. The setting may be established for each person.

### Modification of Second Embodiment

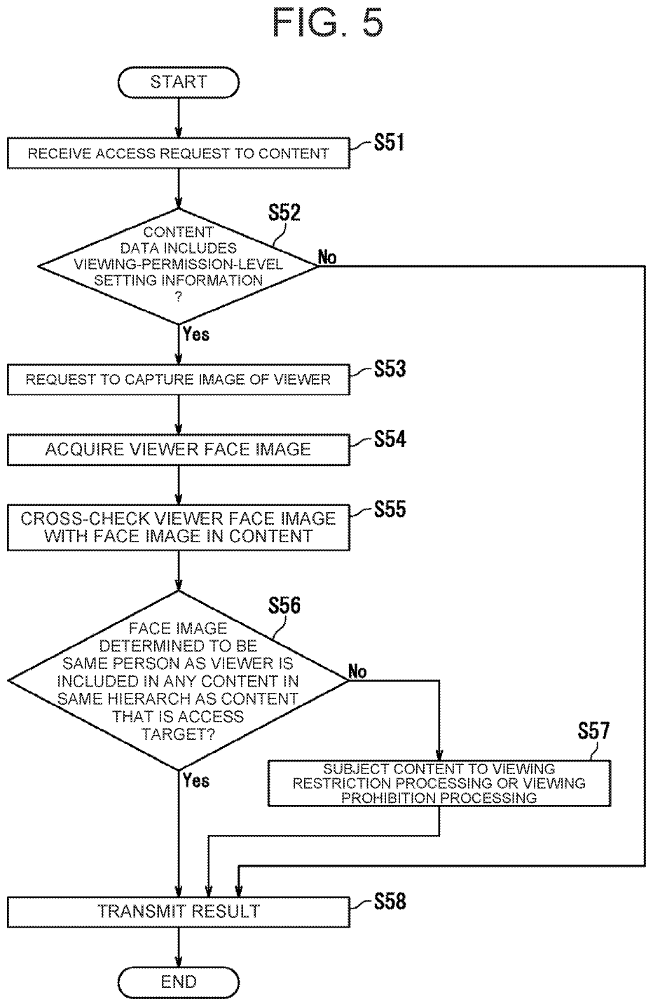

FIG. 5 is a flowchart illustrating a schematic operation of the video management server according to the modification of the second embodiment of the disclosure.

As illustrated in FIG. 5, in step S51, the communicator 22 of the video management server 20 receives a viewing request issued from the personal computer 30.

In step S52, it is determined whether or not the setting information of the viewing permission level is included in the content 40, and if included, the process proceeds to step S53, and if not, the process proceeds to step S58.

In step S53, the personal computer 30 is requested to capture an image of the face of the viewing requester 50 via the communicator 22.

In step S54, a face image is acquired from the personal computer 30 via the communicator 22.

In step S55, the acquired face image is cross-checked with the face image of each subject in the video included in the viewing-request target content.

In step S56, it is determined whether or not a face image determined to be the same person as the viewing requester 50 is included in any content 40 in the same hierarchy as the viewing-request target content, on the basis of the cross-check result in step S55. If it is included, the process proceeds to step S58, and if not, the process proceeds to step S57.

In step S57, predetermined image processing or viewing prohibition processing for reducing visibility is executed on the face region of each subject other than the viewing requester 50.

Finally, in step S58, the viewing-request target content is transmitted to the personal computer 30 via the communicator 22.

According to such a configuration, when information to be kept secret from people other than members appears in a photographic image of an event or the like of limited members, even if a person does not appear in the photograph, the viewing condition is changed depending on whether or not the viewer is included in any of the images included in the same classification hierarchy or group. As a result, it is possible to share the viewing-request target content with limited members, and to restrict the viewing of the content to people other than the limited members.

### Third Embodiment

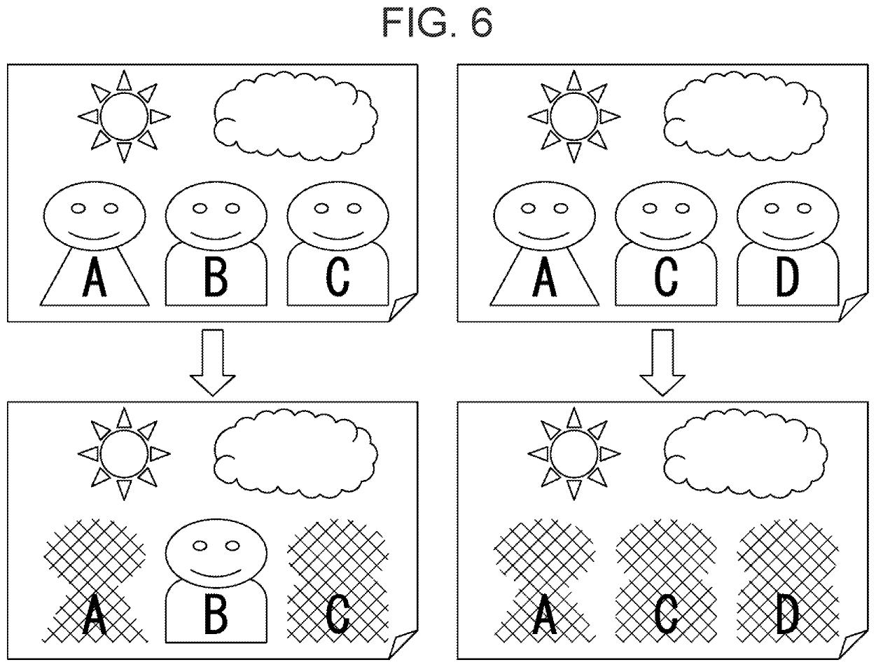

FIG. 6 is an explanatory diagram illustrating relationship determination and viewing conditions by the video management system according to the third embodiment of the disclosure. As in the embodiment described above, it is assumed that person B is the viewing requester 50.

The relationship in the third embodiment is whether or not each subject in the video included in the content 40 is the viewing requester 50. That is, it is determined whether or not each person in the video is the viewing requester 50.

For example, as illustrated in the upper left of FIG. 6, in the case of a photograph in which persons A, B, and C appear, persons A and C are not the viewing requester 50. Therefore, as illustrated in the lower left of FIG. 6, predetermined image processing is executed on these person regions. Since person B is the viewing requester 50, such image processing is not executed.

As illustrated in the upper right of FIG. 6, when a photograph in which persons A, C, and D appear, none of the persons is the viewing requester 50. Therefore, as illustrated in the lower right of FIG. 6, predetermined image processing is executed on all person regions.

According to such a configuration, by specifying which subject is the viewing requester 50, it is possible to always control the viewing condition with respect to the viewer other than the viewing requester 50.

### Fourth Embodiment

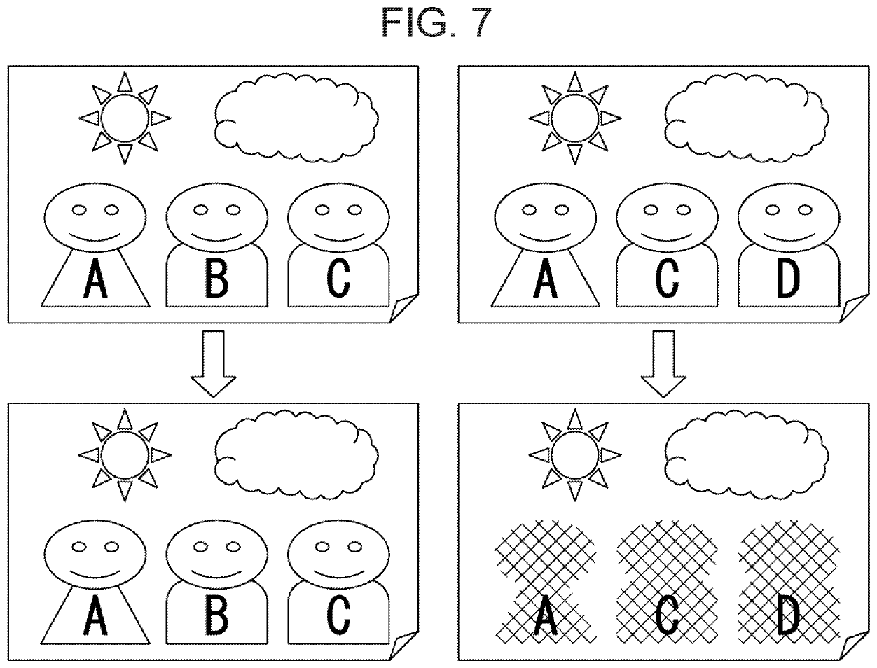

FIG. 7 is an explanatory diagram illustrating relationship determination and viewing conditions by the video management system according to the fourth embodiment of the disclosure.

The relationship in the fourth embodiment is whether or not the viewing requester 50 is included in any of the subjects in the video included in the content 40.

For example, as illustrated in the upper left of FIG. 7, when a photograph in which persons A, B, and C appear, the viewing requester 50 is included in these persons. Therefore, as illustrated in the lower left of FIG. 7, each person is allowed to be viewed in the original video without executing predetermined image processing.

As illustrated in the upper right of FIG. 7, when a photograph in which persons A, C, and D appear, the viewing requester 50 is not included in these persons. Therefore, as illustrated in the lower right of FIG. 7, predetermined image processing is executed on all person regions.

According to such a configuration, by determining whether or not the viewing requester 50 is included in each video, persons appearing in the same video can share the video.

### Fifth Embodiment

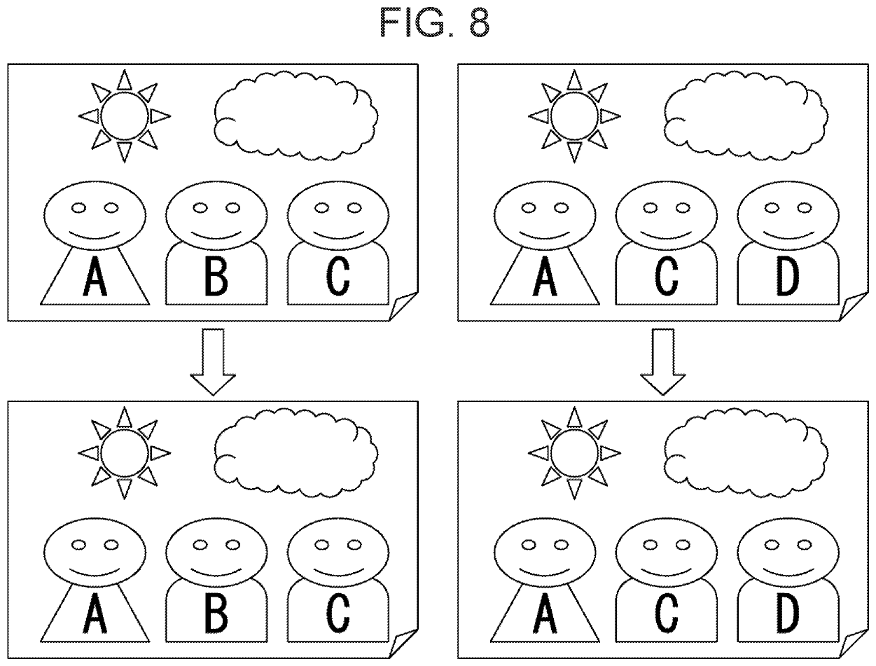

FIG. 8 is an explanatory diagram illustrating relationship determination and viewing conditions by the video management system according to the fifth embodiment of the disclosure.

The relationship in the fifth embodiment is whether or not the viewing requester 50 is included in any of the videos included in each content 40 in the same classification hierarchy or group as the viewing-request target content. Here, the “classification hierarchy” specifically means a hierarchy of a folder when the content 40 managed by the video management server 20 is classified by creating a folder for each event type, name, or year, month, and day in the storage 21. For example, if the viewing-request target content was captured on Jan. 1, 20XX, it is determined whether or not the viewing requester 50 is included in any one of the other content 40 stored in the folder for Jan. 1, 20XX in which the content requested to be viewed is stored.

For example, as illustrated in the upper left of FIG. 8, when a photograph in which persons A, B, and C appear, the viewing requester 50 is also included in these persons. Similar to the above-described fourth embodiment, as illustrated in the lower left of FIG. 8, each person is allowed to be viewed in the original video without executing predetermined image processing.

As illustrated in the upper right of FIG. 8, when a photograph in which persons A, C, and D appear, the viewing requester 50 is not included in these persons. However, since the photograph in the upper left of FIG. 8 in the same classification hierarchy includes the viewing requester 50, as illustrated in the lower right of FIG. 8, each person is allowed to view the original video without executing the predetermined image processing.

According to such a configuration, by determining whether or not the viewing requester 50 appears in an image for each classification hierarchy or group including the content 40, for example, persons belonging to the same group or persons participating in the same event can view a common content 40.

### Sixth Embodiment

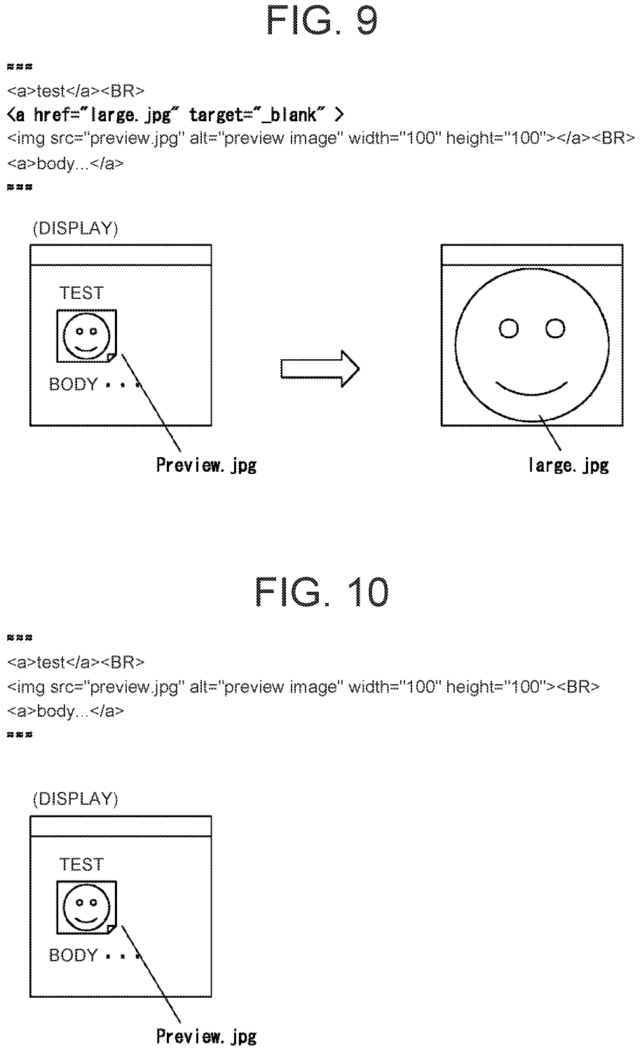

FIG. 9 is an explanatory diagram exemplifying a case where the viewing condition is unlimited by the video management system according to the sixth embodiment of the disclosure. FIG. 10 is an explanatory diagram exemplifying a case where a viewing condition by the video management system is changed from unlimited.

Here, as the content 40, a web page described in HyperText Markup Language (HTML) transmitted from the video management server 20 to the personal computer 30 is assumed. On the web page, for example, preview videos obtained by reducing the size of each video are displayed. When one of the preview videos is clicked, another image of a larger size or the original size (maximum size) of the link destination is displayed.

A change in the viewing condition in the sixth embodiment is, for example, to cancel the above-described link or to change the link destination. Then, the content 40 thus changed is transmitted to the personal computer 30 that has issued the viewing request.

For example, as illustrated in FIG. 9, when the link destination to a preview image Preview.jpg in the content 40 is another image Large.jpg having the same content and a large size, the description portion for designating the link destination is removed as shown in FIG. 10. As a result, the link set in the preview image is invalidated, and no response is made even if the preview image is clicked.

According to such a configuration, in a case where the viewing requester 50 and the viewing-request target content are unrelated or have a weak relationship, it is possible to protect personal information by restricting the content 40 so that it is not provided at high resolution.

### Seventh Embodiment

In each of the above-described embodiments, the viewer video received from the personal computer 30 is handled as an actual face image of the viewing requester 50. However, the possibility of so-called “spoofing” must also be assumed.

For example, an image or video stored in advance in the storage 21 of the personal computer 30 may be transmitted intentionally or erroneously. The viewing requester 50 may intentionally present a face photograph of another person, a display device displaying an image of another person or reproducing a video of another person, or the like to the camera 31.

In order to guarantee that the viewer video received from the personal computer 30 is the actual face image of the viewing requester 50, for example, the following control is preferably added.

### 7.1 Instruct not Only Capturing a Face Image but Also Instructing a Predetermined Gesture

The viewer information requester 24 requests the personal computer 30 to capture an image of the face of the viewing requester 50, and instructs the viewing requester 50 to perform a predetermined gesture, for example, a movement of a hand and fingers (a hand movement representing “rock, scissors, paper,” a number, or the like). The instruction content may be displayed on the monitor 33 of the personal computer 30. The gesture corresponds to a “body motion” of the disclosure.

The viewing requester 50 performs the instructed gesture by putting fingers in front of the face at the time of image capturing.

The relationship determiner 26 not only determines the relationship between the viewer video received from the personal computer 30 and the viewing-request target content, but also checks whether or not the instruction is reflected in the viewer video.

According to such a configuration, although there is a possibility of “spoofing” presenting a face photograph or the like of another person, it is possible to determine “spoofing” by detecting a mismatch such as a difference in the way (direction) or color temperature of illumination light between the face region and the finger region or a mismatch in the positional relationship. The time required for the cross-check is relatively short, and a special camera or sensor is not required.

### 7.2 Instruct a Face State at the Time of Image Capturing, for Example, a Face Direction, a Facial Expression, Blinking, and the Like

The viewer information requester 24 requests the personal computer 30 to capture an image of the face of the viewing requester 50, and instructs the viewing requester 50 about the state of the face, for example, the direction of the face, facial expression, blinking, and the like. The instruction content may be displayed on the monitor 33 of the personal computer 30. Alternatively, the instruction may be given by voice.

The viewing requester 50 changes the state of the face at the time of image capturing in accordance with the instruction.

The relationship determiner 26 not only determines the relationship between the viewer video received from the personal computer 30 and the viewing-request target content, but also checks whether or not the instruction is reflected in the viewer video.

According to such a configuration, by moving the face, it is possible to confirm that the object is not a planar object such as a photograph but a three-dimensional object. The direction and timing of moving the face are displayed on the monitor 33 of the personal computer 30, or the instruction voice is reproduced by the speaker 36, so that it can be made difficult to prepare a moving image in advance. When the moving image is switched to another moving image prepared in advance, a switching lag of the screen, an instantaneous positional shift, or the like occurs, and thus it is possible to detect that the moving image is fraudulent.

Since multiple face images having different orientations can be obtained, it is possible to expect an improvement in the cross-check accuracy when a subject in an image included in the viewing-request target content is not a front face. Although a special camera, sensor, or the like is not required, moving image capturing or continuous image capturing of still images is required.

### Eighth Embodiment

In the above-described seventh embodiment, detection of “spoofing” is attempted with the same configuration as in the first embodiment, but in the present embodiment, a part of the configuration is changed.

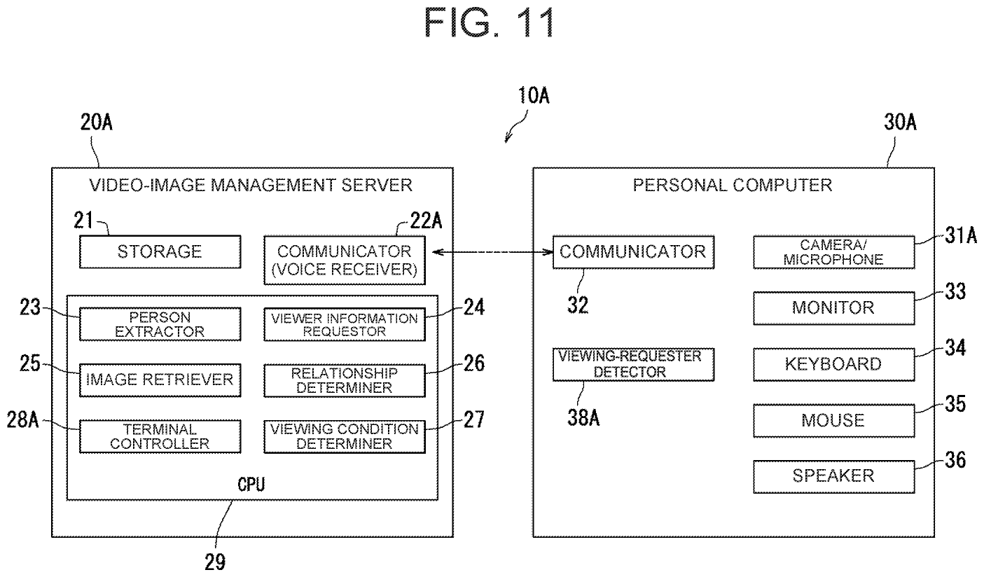

FIG. 11 is a block diagram illustrating a schematic configuration of a video management system 10A according to the eighth embodiment of the disclosure.

As illustrated in FIG. 11, the video management system 10A includes a video management server 20A that manages content 40 and a desktop personal computer 30A that is used by a viewing requester 50 (person B, for example) to issue a viewing request for the content 40.

The difference from the video management system 10 according to the first embodiment is that, in the video management server 20A, a communicator 22A also has the function of a “voice receptor” of the disclosure, and the video management server 20A includes a terminal controller 28A that remotely controls the function of the personal computer 30A. As for the personal computer 30A, a camera/microphone 31A is a camera with a built-in microphone capable of voice input, and the personal computer 30A is provided with a viewing-requester detector that detects the replacement of the viewing requester 50.

### 8.1 Instruction to Read Out a Character String or Other Types of Information

The viewer information requester 24 requests the personal computer 30 to capture an image of the face of the viewing requester 50, and instructs the viewing requester 50 to read aloud a character string or other types of information. The instruction content may be displayed on the monitor 33 of the personal computer 30. The character string and other types of information are examples of “predetermined information” of the disclosure.

The voice of the viewing requester 50 reading out the character string or other types of information displayed on the monitor 33 is input to the camera/microphone 31A and transmitted to the video management server 20A via the communicator 32. This voice corresponds to a “viewer voice” of the disclosure.

The voice transmitted from the personal computer 30 in this way is received by the video management server 20A via the communicator 22A, which also serves as the “voice receptor.”

According to such a configuration, it is possible to determine whether or not “spoofing” has occurred on the basis of whether or not the voice for the displayed character string is correctly input and whether or not the movement of the mouth matches the reading. As a result, it is possible to make it difficult to illegally prepare a moving image in advance. Although a special camera or sensor is not required, moving image capturing and voice input are required. When the mouth is hidden by a mask or the like, it is difficult to make an accurate determination.

### 8.2: Check Whether or not a Camera Control Signal is Transmitted and Reflected in a Video

In the video management system 10A, since various functions of the camera/microphone 31A of the personal computer 30A can be remotely controlled from the video management server 20A, it is possible to check whether or not the camera control signal transmitted from the video management server 20A is reflected in the face image of the viewing requester 50. Camera functions suitable for such check include, but are not limited to, exposure conditions, color temperature settings, illumination assist light settings, zoom, etc. Note that these camera functions correspond to “some functions related to image capturing” of the disclosure.

According to such a configuration, “spoofing” can be effectively prevented. However, not only moving image capturing or continuous image capturing of still images is required, but also it is necessary to control the camera 31 of the personal computer 30 from the outside. Even if the camera 31 of the personal computer 30 can be controlled from the outside, there is a possibility that the psychological resistance of the viewing requester 50 becomes high when the camera 31 is controlled by the video management server 20.

### 8.3 Detection of Replacement of the Viewing Requester 50 by the Personal Computer 30A

In the second modification of the first embodiment described above, the replacement of the viewing requester 50 is detected in the video management server 20, but in the video management system 10A according to the eighth embodiment, the replacement of the viewing requester 50 is detected by a viewing-requester detector 38A of the personal computer 30A.

The viewer video first captured by the camera/microphone 31A is transmitted to the video management server 20A. Then, when the viewing-requester detector 38A detects that the viewing requester 50 has been replaced, the viewer video is transmitted again to the video management server 20A.

Every time the viewer video is received from the personal computer 30, the relationship determiner 26 of the video management server 20A determines the relationship between the viewer video and the viewing-request target content.

According to such a configuration, even if the viewing requester 50 is replaced, the viewing-request target content can be appropriately provided.

### Ninth Embodiment

The viewer information requester 24 of the video management server 20 described above may request the personal computer 30 that has issued the viewing request to capture a moving image of the face of the viewing requester 50.

According to such a configuration, for example, while the skin does not move in a still image (photograph), the skin naturally moves delicately in a moving image, which is a characteristic unique to a moving image (video image), and therefore, it is possible to perform the authentication of the identity of the viewing requester 50 with high accuracy.

### Tenth Embodiment

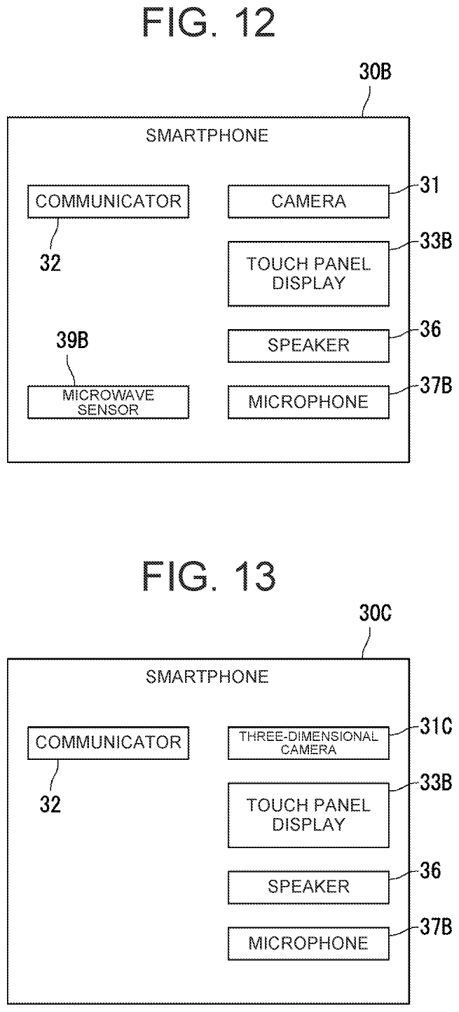

FIG. 12 is a block diagram illustrating a schematic configuration of a smartphone 30B according to the tenth embodiment of the disclosure. The smartphone 30B is also an example of a “terminal” of the disclosure.

The video management system 10 according to the first embodiment is functionally different from the desktop personal computer 30 in that a touch panel display 33B in which the functions of the monitor 33, the keyboard 34, and the mouse 35 of the personal computer 30 are substantially integrated is mounted. Furthermore, an independent microphone 37B and a microwave sensor 39B are provided.

The microwave sensor 39B, as a Doppler radar, can detect in a non-contact manner biological information such as heartbeat, respiration, and body movement of humans, animals, and the like, and thus can determine whether a face image is a that of a living body or a non-living body.

According to such a configuration, “spoofing” can be effectively prevented.

### Eleventh Embodiment

FIG. 13 is a block diagram illustrating a schematic configuration of a smartphone 30C according to the eleventh embodiment of the disclosure. The smartphone 30C is also an example of a “terminal” of the disclosure.

The video management system 10 according to the first embodiment is functionally different from the desktop personal computer 30 in that a touch panel display 33B is mounted as in the tenth embodiment and an independent microphone 37B is provided. Furthermore, the camera 31 is replaced with a three-dimensional camera 31C which three-dimensionally recognizes an object scene by infrared rays.

By detecting the three-dimensional shape of the face of the viewing requester 50, the three-dimensional camera 31C can check a three-dimensional object that is not a planar object, such as a photograph or a video, and can also improve the accuracy of cross-check with an image other than a front face.

According to such a configuration, “spoofing” can be effectively prevented.

### Other Embodiments

A computer-readable recording medium storing a video management program according to the disclosure is a non-temporary tangible computer-readable recording medium storing a program for causing a computer to execute a video management process. The video management processing includes: a viewer information requesting step of requesting a terminal that has issued a viewing request to capture an image of the face of a viewing requester; a relationship determining step of determining a relationship between a viewer video received from the terminal and a viewing-request target content that is a target of the viewing request in the content; and a viewer condition determining step of determining a viewing condition of the viewing-request target content in accordance with the relationship. Computer-readable media may include transitory computer-readable media (e.g., a signal). Combinations of the above should also be included within the scope of computer-readable media.

1. A video management device comprising:
a storage that stores content;
a viewer information requester that requests a terminal issuing a viewing request to capture an image of a face of a viewing requester;
a relationship determiner that determines a relationship between a viewer video received from the terminal and a viewing-request target content being a target of the viewing request in the content; and
a viewing condition determiner that determines a viewing condition of the viewing-request target content in accordance with the relationship.

2. The video management device according to claim 1, wherein the viewer information requester requests the terminal to capture an image the face of the viewing requester when the viewing-request target content includes a face video.

3. The video management device according to claim 1, wherein the viewing-request target content includes setting information of a viewing permission level in advance, and the viewing condition determiner determines the viewing condition based on the setting information.

4. The video management device according to claim 1, wherein the relationship is determined in accordance with whether or not each subject in a video included in the viewing-request target content is a person in the viewer video.

5. The video management device according to claim 1, wherein the relationship is determined in accordance with whether or not any subject in a video included in the viewing-request target content is a person in the viewer video.

6. The video management device according to claim 1, wherein the relationship is determined in accordance with whether or not any subject in all videos included in a same classification hierarchy as the viewing-request target content is a person in the viewer video.

7. The video management device according to claim 1, wherein, when the viewing condition is changed from unlimited, video processing including any one of blurring, mosaic processing, resolution reduction, and replacement with an avatar or another person video is executed on at least a face region of a subject in a video included in the viewing-request target content.

8. The video management device according to claim 1, wherein when the viewing condition is changed from unlimited and when a video displayed in the viewing-request target content transmitted to the terminal includes a link to another video having the same content and a larger size, the link is removed from the viewing-request target content.

9. The video management device according to claim 1, wherein,
the viewer information requester requests the terminal to continuously, intermittently, or irregularly capture an image the face of the viewing requester,
the relationship determiner redetermines the relationship between the viewer video and the viewing-request target content when replacement of viewing requester is detected based on the viewer video received from the terminal, and
the viewing condition determiner redetermines the viewing condition of the viewing-request target content in accordance with the relationship redetermined.

10. The video management device according to claim 1, further comprising:
a voice receptor that receives voice from the terminal, wherein,
the viewer information requester causes the terminal to display predetermined information and instructs the terminal to read aloud the predetermined information, and
the relationship determiner determines the relationship between the viewer video and the viewing-request target content, based on the viewer video received from the terminal and the viewer voice received by the voice receptor and on the predetermined information.

11. A video management system comprising:
a video management device; and
a terminal, wherein,
the video management device includes:
a video-management-device-side communicator that communicates with the terminal;
a storage that stores content;
a viewer information requester that requests the terminal issuing a viewing request to capture an image of a face of a viewing requester;
a relationship determiner that determines a relationship between a viewer video and a viewing-request target content each time the viewer video is received from the terminal, the viewing-request target content being a target of the viewing request in the content; and
a viewing condition determiner that determines a viewing condition of the viewing-request target content in accordance with the relationship, and
the terminal includes:
an image capturer that continuously, intermittently, or irregularly captures image of a face of the viewing requester;
a viewing-requester detector that detects replacement of the viewing requester based on the viewer video captured by the image capturer; and
a terminal-side communicator that transmits the viewer video first captured by the image capturer to the video management device, and transmits the viewer video to the video management device when the viewing-requester detector detects replacement of the viewing requester.

12. A video management method comprising:
requesting a terminal issuing a viewing request to capture an image of a face of a viewing requester;
determining a relationship between a viewer video received from the terminal and a viewing-request target content being a target of the viewing request in the content; and
determining a viewing condition of the viewing-request target content in accordance with the relationship.
